(19) United States
(12) Patent Application Publication
(10) Pub. No.: US 2011/0218855 A1
(43) Pub. Date: Sep. 8, 2011

(54) Offering Promotions Based on Query Analysis

(75) Inventors: Yu Cao, Monterey Park, CA (US); Leonard Kleinrock, Los Angeles, CA (US)

(73) Assignee: PLATFORMATION, INC., Monterey Park, CA (US)

(21) Appl. No.: 13/038,150

(22) Filed: Mar. 1, 2011

Related U.S. Application Data
(60) Provisional application No. 61/310,004, filed on Mar. 3, 2010.

(51) Int. Cl. G06Q 30/00

(52) U.S. Cl. 705/14.49

(57) ABSTRACT

Methods of providing promotions to consumers are presented. Query behavior of one or more consumers can be monitored to map the behavior or changes in behavior to concepts or intent. Advertisers can pay a fee in exchange for providing promotions to the consumers and relating to the concepts.

This application claims the benefit of priority to U.S. provisional application having Ser. No. 61/310,004, filed on Mar. 3, 2010. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is advertising technologies.

### BACKGROUND

Presenting promotions to consumers has evolved a great deal over the last few decades. One key technology of recent years includes offering advertisements based on keywords entered into a search engine. Such approaches have generated billions of dollars in revenue by providing services to advertisers allowing them to associate promotions with submitted keywords in exchange for a fee. When a user enters a search term into a search engine, the engine matches the terms with an advertiser's keywords. The engine returns search results along with promotions from the advertiser. The success of the technology has been astounding. However, the keyword approach has many limitations.

One limitation of advertising based on keywords is that a user's search terms do not always reflect the user's intent. For example, a user could submit “game” into a search engine, but the user's intent or goal is vague at best. The word “game” could pertain to video games, board games, wild game, gambling, or other concepts. Unfortunately, an advertiser offering video game promotions who has purchased the keyword “game” will have their promotions wastefully presented to individuals who are interested in other concepts and would be unlikely to click through the promotions.

The deficiencies of keyword advertising are exacerbated in shopping environments where consumers select multiple products or items for purchase. A list of products offers little guidance to a search engine or advertisers on what an appropriate promotion would or should be to match a user's intent, goal, or desired concept. For example, an individual could be shopping for groceries by searching for a list of items, possibly including milk, eggs, and flour. However, a search engine has difficulty determining which of the three terms is most relevant. Consequently, irrelevant promotions are displayed to the consumer.

More preferably, a search engine, shopping site, or other computer query system would be able to derive some level of understanding of an intent, goal, or concept for which a consumer is searching. Thus, effort has been put forth toward providing semantic search engines in various forms. Semantic search algorithms aid a consumer or other searcher, but offer little or no support for the advertiser.

Solutions to such issues have been lightly discussed in the inventor's own work. U.S. patent application having Ser. No. 11/754,081 titled “Searching With Consideration Of User Convenience” filed on May 24, 2007, has a brief discussion regarding offering concepts to advertisers.

What has yet to be appreciated is that a searcher's concept or intent can be considered a valuable, purchasable commodity to advertisers or other promoters. For example, a consumer entering a grocery list of milk, eggs, and flour could indicate the consumer plans on baking, making breakfast, or other intention. An appropriately configured computer system can analyze the list and map the list to one or more a priori defined concepts. When the computer system returns results, the computer system can also return promotions from advertisers that have attached their brands to the concepts. Of course an advertiser would pay a fee for attaching their brand to a concept. Furthermore, a query history can be tracked to detect changes in query behavior. Advertisers could also pay to have their promotions presented to consumers based on characteristics of the change or delta in query behavior

Thus, there is still a need for advertising technologies.

### SUMMARY OF THE INVENTION

The inventive subject matter provides apparatus, systems and methods in which promotions can be offered to consumers based on an analysis of query behaviors to derive a consumer's intent, concepts, or change in behavior. One aspect of the inventive subject matter includes methods of providing an advertising platform. For example, a concept engine can be configured to store one or more concept maps, where each map comprises a quantified representation of a generic concept (e.g., lunch, dinner, Easter, Halloween, birthday, etc.). The concept maps can be described by attributes having values, or multiple values, that conform to a normalized namespace. The method can include allowing an advertiser to interact with the concept engine, and to select one or more concept maps. The advertiser can pay a fee in exchange for having their promotions bound to the selected concept maps. The concept engine can receive a query from a user, possibly via a query engine, where the concept engine maps the query to one or more of the known or defined concepts maps. When the advertiser's selected concept map appears to have a correlation with the user's query, the advertiser's promotion can be also be presented along with search results.

Another aspect of the inventive subject is considered to include methods of offering a promotion to a user. In some embodiments, one can provide a query processing engine capable of storing one or more sets of queries. The processing engine can track a history of each set of queries over time. For example, a set of queries could include a history of queries submitted by a single user, or a group of users having a common characteristic (e.g., demographic, hobby, etc.). The processing engine can detect if a change has occurred in a query set relative to the historical behavior or baseline of a set of queries. A detected change could be indicative of a change in a user's behavior or intent. When the change satisfies change criteria, the processing engine can provide a corresponding promotion to the entity submitting the query.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of a system capable of mapping queries to concept maps.

FIG. 2 is a schematic of a possible consumer interface configured to allow a consumer to shop on line.

FIG. 3 is a schematic of a possible query analysis engine configured to track query behaviors.

FIG. 4 provides and illustration of mapping a shopping list to one or more concepts maps.

FIG. 5 provides an illustration of mapping concepts to promotions.

FIG. 6 provides an illustration of a concept map space having overlapping concepts and disjoint concept maps.

FIG. 7 provides an illustration of two disjoint concept maps having similar sub-maps.

FIG. 8 is a schematic of a method of providing an advertising platform.

FIG. 9 is a schematic of a method of offering a promotion.

### DETAILED DESCRIPTION

It should be noted that while the following description is drawn to a computer/server based query or analytic engines, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including an infrastructure capable of coordinating communication among various processing engines and configuring remote interfaces to present one or more promotions associated with a user's shopping list query.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

### Query to Concept Mapping

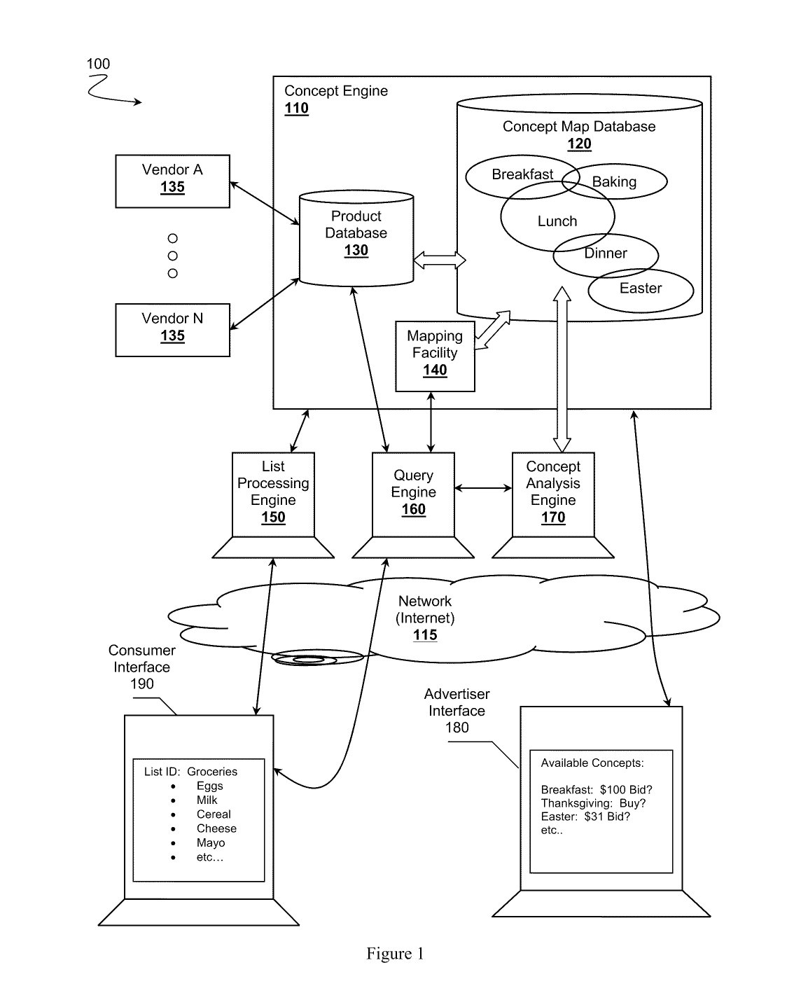

FIG. 1 presents an overview of system 100 where a consumer's query, possibly comprising a grocery list, is mapped to one or more concepts stored in concept map database 120.

Concept engine 110 can comprise product database 130 storing product information from a plurality of vendors 135. Concept engine 110 can also store one or more concept maps relating to the products in product database 130. The concept maps can be automatically generated by analyzing product information possibly via concept analysis engine 170 or manually generated possibly through advertiser interface 180. The various components of system 100 can be communicatively coupled with each other over network 115 (e.g., Internet, WAN, LAN, etc.).

Concept maps can be automatically generated using suitable algorithms applied to information stored in product database 130 or other information sources. Product information can include product name, product type, metadata about the product, SKUs, brand, size, quantity, quality, volume, weight, nutritional value, make, model, purchasing history, or other information. Other information sources can include books, blogs, forums, previously submitted queries, audio streams, video streams, images, or external information sources that preferably reference the products. Suitable algorithms that can be applied to generate a concept map can include latent semantic analysis, n-gram modeling, Markov modeling, natural language processing, or other algorithms that can form a well defined concept from aggregated data.

A concept map can, at a basic level, represent a list of terms (e.g. keywords, attributes, metadata, etc.) that appear to be related. In more preferred embodiments, concept maps are more complex. A more complex concept map can be based on geography, language, time, network address, demographics, psychographics, programmatic instructions or rules, relational operators (e.g., AND, OR, XOR, NOT, etc.), or other data.

In a preferred embodiment, system 100 offers advertiser interface 180 through which an advertiser can select one or more concepts of interest as represented by concept maps in concept map database 120. The advertiser can pay a fee to attach their brand to the selected concepts by providing one or more promotions to be presented to a consumer when the consumer appears to have an interest in the concept. The advertiser can pay a fee through many different means including paying a basic fee, a subscription fee, a per-impression fee, a fee resulting from an auction for the concept, an exclusivity fee, or other types of fees.

A consumer can interface to a query engine through consumer interface 190 possibly provided by query engine 160. In the example shown, a consumer submits a query comprising a list of products for a grocery list, possibly stored or managed by list processing engine 150. Query engine 160 can obtain search results, possibly from product database 130, that relate to the listed items. In one preferred embodiment, query engine 160 can also interface to mapping facility 140 that utilizes the query information to map the query to one or more concepts as related to the concept maps. It is specifically contemplated that query information can include the submitted query, a query history for the consumer or others, or other information relating to the query. Mapping facility 140 can identify related concept maps, possibly based on a probability of matching a query to the various available concept maps. When results are returned to the consumer via consumer interface 190, concept engine 110 can also provide promotions of advertisers that have paid to have their brands attached to the corresponding concepts.

Consider an example as shown where a grocery list includes eggs, milk, cereal, cheese, and mayonnaise. Mapping facility 140 might conclude the list appears to represent that the consumer intends to purchase products relating to breakfast, lunch, or possibly baking. When search results are returned to the consumer via consumer interface 190, concept engine 110 also provides promotions from advertisers that have paid to have their brands identified with breakfast, lunch, or baking Ranking of the promotions can be determined by any suitable algorithm, possibly based on fee amount, probability of matching a concept map, consumer preferences, prices, or other parameters.

Query engine 160 can comprise a search engine, concept engine 110, an on-line vendor server, a shopping comparison site, or other computer system. In some embodiments, query engine 160 operates as a publicly accessible search engine (e.g., Google™, Yahoo!™, Bing™, etc.), while in other embodiments, query engine 160 can be integral with concept engine 110.

### Consumer Interface

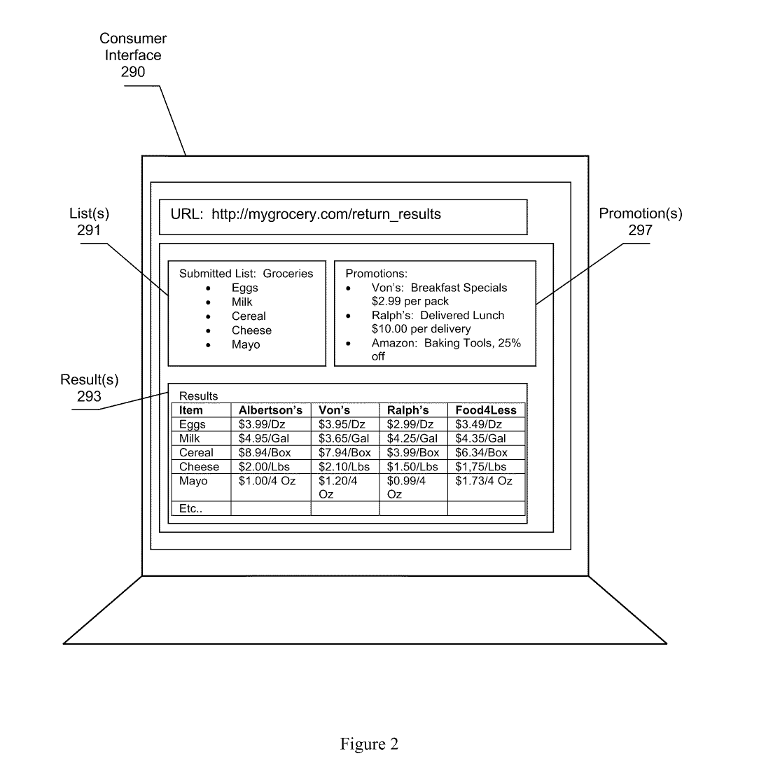

FIG. 2 illustrates a possible embodiment of consumer interface 290 after a consumer submits a query to the concept engine. In the example shown, a consumer submitted grocery list 291 as a query. The mapping facility maps list 291, or items in list 291, to one or more concepts; in this example the concepts are breakfast, lunch, or baking. In response, the query engine provides information relating to list 291 as well as promotions 297 relating to the identified concepts.

In a preferred embodiment, the query engine and concept engine function as components of an on-line retailer. Consumers can create bundles of products where products are offered from one or more individual vendors or from across multiple, distinct or unaffiliated vendors. Preferably, results 293 received by a consumer are presented in a format allowing for easy comparison. For example, results 293 can be presented in a side-by-side comparison as represented by the result table for the consumer's grocery list 291.

### Query Behavior Analysis

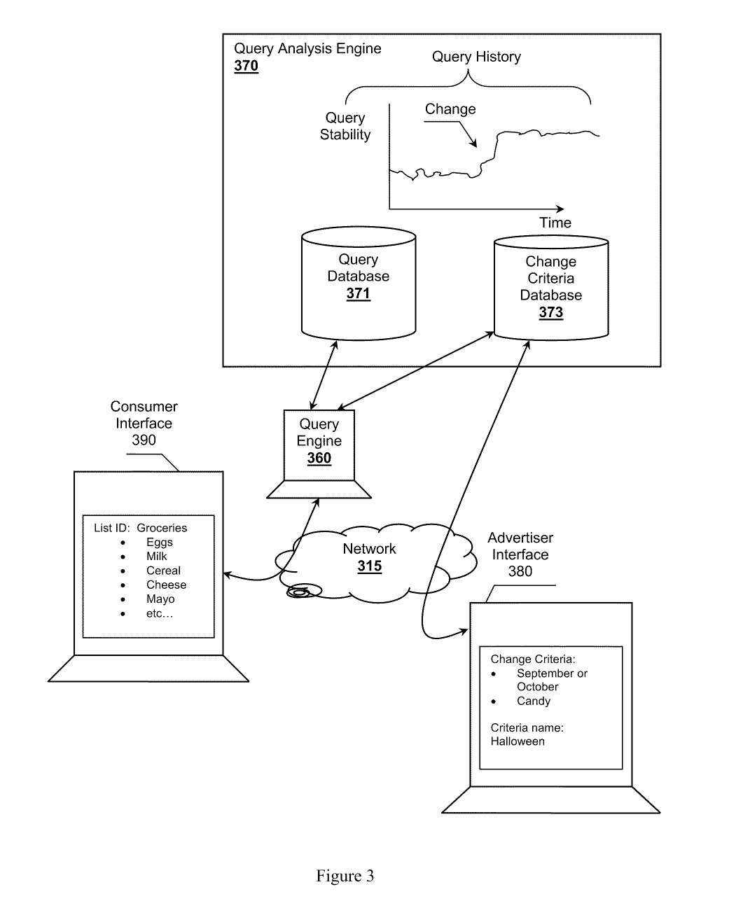

FIG. 3 presents yet another aspect of the inventive subject matter where query analysis engine 370 tracks query behavior over time. As a consumer, or many consumers, submits queries to query engine 360 over network 315, the queries can be stored within query database 371 for later retrieval and analysis. Information stored within query database 371 can include the query itself, metadata related to the queries, language of the query, geographic location from which the query was submitted, demographics relating to the consumer, or other information relating to the queries or their properties. In some embodiments, query properties are stored according to a common attribute namespace utilized by concept maps, product information, or other objects in the system.

Query analysis engine 370 can monitor the query behavior of consumers to detect changes in queries over time (see Query History Graph in FIG. 3). The change could represent a possible shift in an underlying concept backing the queries, intent of the consumers, or other changes. Analysis engine 370 can quantify the change or delta based on the changed characteristics. Contemplated characteristics that could be monitored for changes could include timing relating to queries (e.g., rate, data, week, etc.), price or cost associated with terms of the query, language used, location, or other parameters. One should appreciate that the change can be represented as a multi-valued or multi-dimensional data object reflecting many different query attributes.

As with the previous discussion, the change in a query behavior can also be considered a valuable commodity for advertisers. The change could represent a point in time when a consumer would be more likely to accept a promotion that aligns with their change in behavior. An advertiser can define change criteria representing desirable changes in query behavior, possibly via advertiser interface 380. When analysis engine 370 detects that a query behavior change satisfies the defined change criteria stored in change criteria database 373, analysis engine 370 can return the advertiser's promotion to the consumer at consumer interface 390. The change criteria are preferably based on parameters associated with queries and can include rules, instructions, or other conditions. Change criteria are preferably stored in change criteria database 373 that can be accessed by the analysis engine 370. Change criteria can include rules or conditions relating to query attributes as represented in the common attribute namespace. By representing various objects (e.g., queries, products, concept maps, etc.) within the common attribute namespace, one can readily compare one object to other objects.

In the example shown, query database 371 tracks a history of a consumer's submitted grocery list. An advertiser has defined criteria for a behavior change of interest. The criteria require that the change in the grocery list includes candy and that the list is submitted in September or October. The advertiser has named their campaign “Halloween” to indicate that the promotions will target Halloween shoppers.

One should appreciate that the change or delta of the behavior is considered of value above and beyond a behavior baseline. Identification of such changes can be readily applied to queries comprising lists of products. Changes could include a change in brand while the type of product remains the same, change in products, change in prices, change in number of products in the list, rate at which the list is submitted, or other query characteristics.

Queries having common properties, possibly having a common attribute in the attribute namespace, across multiple consumers can also be analyzed to provide valuable opportunities to advertisers. Such approaches can be valuable when a single consumer has a small change in behavior that would not be readily apparent. For example, a consumer might change brands of peanut butter. However, if many consumers in the same zip code exhibit the same change, then this could indicate a trend or a shift in the market. Advertisers could utilize changes in collective query behavior for providing appropriate promotions, measuring buzz around products, or other purposes, all in exchange for an appropriate fee. Contemplated common properties could include geographic location, demographics, brands, prices, or other parameters that can be associated with queries.

It is also contemplated that changes in query behavior can also be quantized and can be associated or correlated with concept maps as discussed above.

### Example

### Keywords as Concept Map

The following discussion represents an example of how concept maps can be used by advertisers or other promoters to attach their brand to a concept. The example uses keywords as a basis for a concept map. Although the example presents a simplified view of concepts maps, one should appreciate that a concept map can be more complex as discussed above.

The example presented below illustrates how concepts maps can be used in conjunction with a grocery list. One should appreciate that the disclosed techniques can be applied readily to other query related activities including general purpose searches, developing a request for quotes (RFQs), shopping, compiling a bundle of products, or other query related activities.

One should further appreciate that the concept of a query can be boarder than a list of search terms. A query could also include logical operates, regular expression, manually entered information, automatically entered information, metadata, query history, or even information supplied via a back channel between a browser and a search engine that a user would not likely observe.

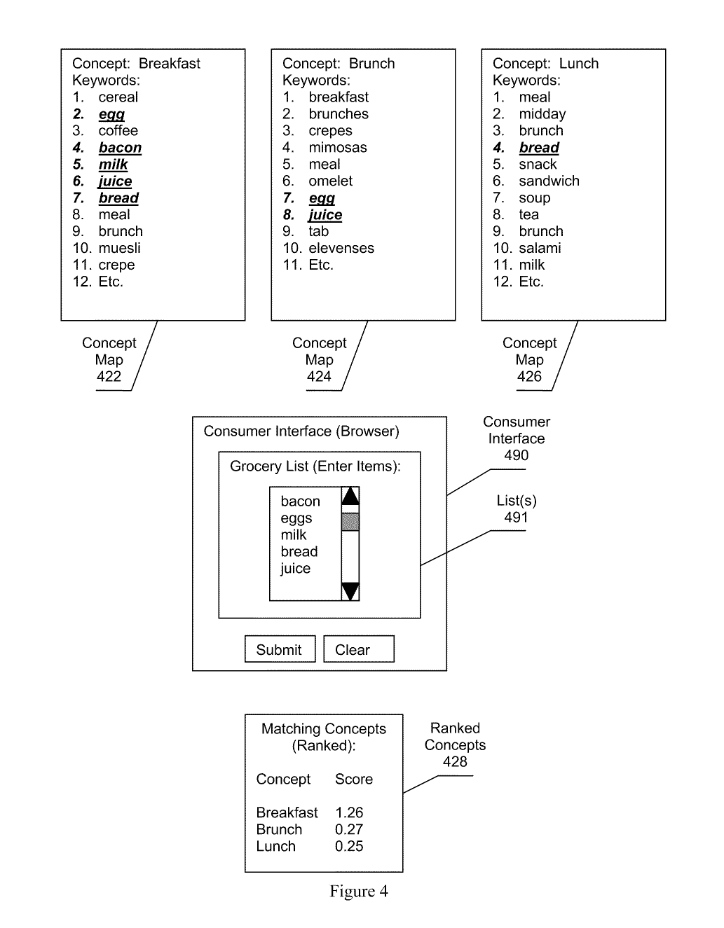

In FIG. 4, various advertisers have purchased rights to concept maps for breakfast, brunch, or lunch as represented by concept maps 422, 424, and 426, respectively. The concepts maps are constructed as a list of keywords that can relate to the concepts. For example, the breakfast concept could be represented by various breakfast related foods including cereal, eggs, coffee, or other items.

Each of the concept 422, 424, and 426 can comprise an ordered list of keywords. One method of generating the list of keywords can include using a thesaurus, a synonym list, a reverse dictionary, or other means for generating keywords that relate to a concept. For example, one could use the reverse dictionary provided by OneLook.com (see URL www.onelook.com) to generate keywords for concept.

A grocery shopper can use consumer interface 490 (e.g., a browser) to enter grocery list 491 having one or more items. List 491 can be considered to represent a query that could be submitted to a search engine, a grocery store, a price comparison web site, or other query engine. In the example shown, a consumer enters the items: bacon, eggs, milk, bread, and juice. Upon submission of list 491, a concept engine can determine how to match the list to one or more concepts by comparing the query to available concept maps, in this case concept maps 422, 424, and 426.

One method of matching a query to a concept map includes identifying keywords in the concept maps 422, 424, and 426 to terms used in the list 491. For example, the list items egg, bacon, milk, juice, and bread match keywords in breakfast. Brunch has two matching keywords, and lunch has a single matching keyword. It is contemplated that the position of the keyword in a keyword mapping could be of value, as illustrated by the following discussion. One should appreciate that other methods of mapping a query to concept maps are also contemplated. For example, the mapping could be through the common attribute namespace, though applying one or more AI algorithms to determine overlap (e.g., neural networks, genetic algorithms, etc.), or other technique.

The concept engine ascertains that the three concepts represented by concept maps 422, 424, and 426 appear to be related to grocery list 491. Preferably, the concept engine determines which of the concepts appears to be most relevant using a suitable algorithm. The algorithm is preferably based on parameters stemming from concept maps 422, 424, and 426 or from the query. Contemplated concept parameters could include keyword position, query terms (e.g., list items), time, date, demographics of searcher, or other parameters associated with they query or query behavior of the searcher. Algorithms can provide a single-valued result per concept map that indicates a relative relevance of a concept map pertaining to a query. It is also contemplated the result of the algorithm can be multi-valued where each value could represent a different relative weight of a particular characteristic of the concept maps.

Although the example presented discusses using a one-to-one mapping of keywords from a query to a concept map, it should be noted that many other algorithms could be used. Another example of an algorithm relating to grocery shopping could include identifying ingredients for a recipe, where the recipe represents a concept (e.g., baking cookies). Still, all algorithms for identifying a concept map are contemplated.

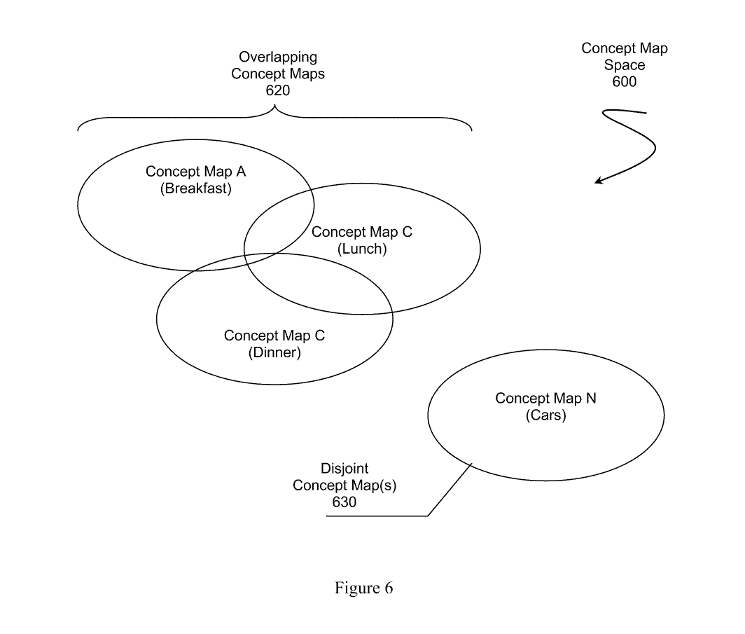

In the example shown, each concept map is assigned a score based on the position of the keywords identified where the score is the sum of the reciprocal of the keyword positions; see the highlighted keywords in FIG. 6. For example, breakfast concept map 422 has a score of 1.26=½+¼+⅕+⅙+ 1/7, brunch concept map 424 has a score of 0.27= 1/7+⅛, and lunch concept map 426 has a score of 0.25=¼. The concept engine arrives at the conclusion that breakfast concept map 422 appears to be the most relevant as indicated in ranked concepts 428. The above scoring algorithm is presented for illustrative purposes only. All possible ranking, scoring, judging, or selecting algorithms are contemplated.

The relative scores can be used by the concept engine to determine how promotions are to be presented to the consumer. In some embodiments, the relative scores can be used to determine promotion placement. Promotions associated with the highest ranked concept map could be placed in the most advantageous position, while promotions associated with lower ranked concept maps can be placed in less advantageous position. In other embodiments available advertising real estate on the consumer interface could be parceled out based on the relative score. One should appreciate that one or more promotions from one or more concept maps can be presented, subject to purchased exclusivity rights.

It is contemplated that a single advertiser attempting to bind their brand to a concept, breakfast for example, could have multiple promotions associated with or bound to a single concept map.

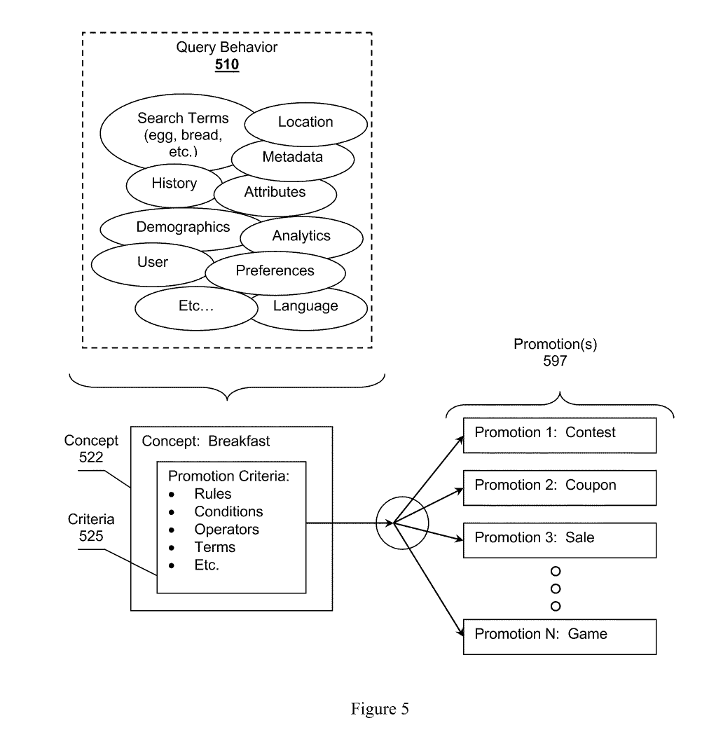

In FIG. 5, an advertiser has paid to have their brand attached to concept 522 representing breakfast and has a plurality of promotions 597 that should be presented to a consumer when the consumer's query matches concept 522. In this example, breakfast appears to be the most relevant concept based on the submitted grocery list items. The advertiser can select one or more of their promotions to be presented back to the consumer. In a preferred embodiment, promotion criteria 525 can be used to aid the in an automated selection of the promotions. The promotion criteria 525 can include rules, conditions, operators, or other types of criterion that can be applied to the consumer's query behavior 510.

In a basic form, promotion criteria 525 could simply use the search terms as a basis for selecting a promotion. For example, if the consumer used the word “egg” in the query, the concept engine could determine that an acceptable promotion from the advertiser might be a coupon for eggs.

In a more complex and a more preferred embodiment, promotion criteria 525 can depend on just about any information available that relates to query behavior 510 overall. It is contemplated that query behavior 510 information supplied to a promotion selector could include search terms, metadata, query history, various attributes associated with the query, demographics of the consumer, user or profile information, analytics, trends, preferences, language, location, or other information. An advertiser can establish promotion criteria 525 as desired based on the provided information.

### Bridging to Disjointed Concept Maps

The disclosed techniques provide for mapping a consumer's query to one or more concept maps. The outlined approach allows for concept maps to overlap as discussed above with reference to breakfast, brunch, or lunch, where multiple advertisers could present their promotions to a consumer. Still, there are instances where it would be desirable to present promotions associated with concept maps that are disjoint or otherwise apparently unrelated to the query concept.

FIG. 6 illustrates concept map space 600 having overlapping concept maps 620 and disjoint concept maps 630. Consider a case where a consumer shopping for groceries exhibits a change in their query behavior, possibly reflecting a change in life style. Perhaps their queries focus on high end brands of food. Such a change in query behavior could be mapped to disjoint concept maps 630 for example. The shift in query behavior toward high-end brands could be correlated by a concept engine with another concept map relating to luxury items, a new car for example.

One possible approach to bridging to disjoint maps can include applying different reasoning methods of comparing a query behavior to the concept maps. Through using different forms of reasoning, the system can generate a discover event where a consumer can be exposed to other maps that would ordinarily be excluded from use. Example types of reasoning can include deductive reasoning, inductive reasoning, or abductive reasoning.

Deductive reasoning applies deterministic logic to input parameters to establishing new correlations among objects. However, the new correlations are bounded by the correlations of the input parameters. Simply put deductive reasoning results in correct correlations, at least to the extent of the algorithms employed.

Abductive reasoning and inductive reasoning provide a framework for making a leap by inferring correlations that might not be correct. Consider inductive reasoning. If all observed 18 year old consumers have purchased a product associated with a concept map, the system can reason that a new 18 year old consumer might like a promotion associated with the concept map. Such reasoning might be correct, but also might not; thus generating a discovery event for the consumer. The discovery event can bridge to a disjoint map because the concept map might not ordinarily align to the new consumer's original intent.

Consider abductive reasoning. The system can observe consumer interactions with concept maps to infer correlations among consumer attributes and concept maps. The correlations can be used to generate hypotheses of whether a new consumer might have similar interests. For example, the system can observe male consumers interacting with a “car” concept map and a “video game” concept map. The system might reason that male consumers like cars and video games. A second consumer might interact with the “video game” concept map, which could cause the system to reason that the consumer might be male and might be interested in cars. Such a leap clearly might not be true in view that the consumer could be female. Still, the result of the abductive reasoning generates a possible discovery event for the second consumer.

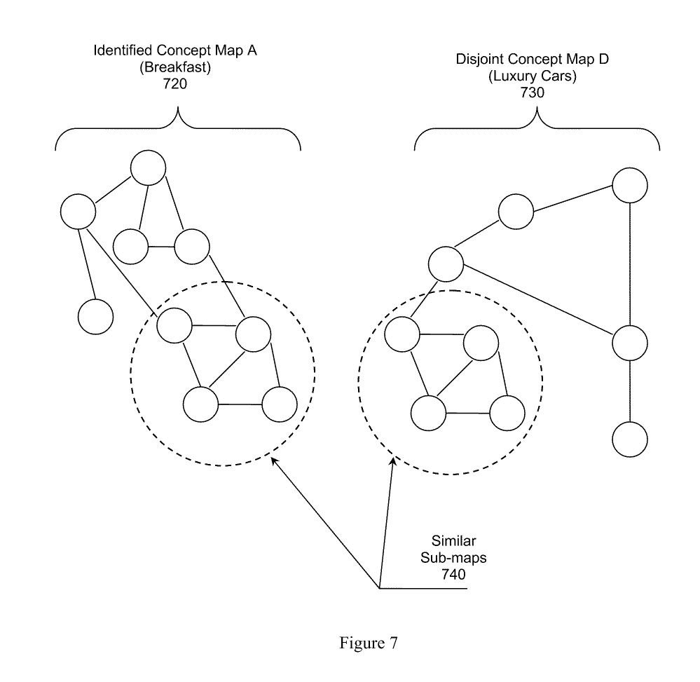

Another possible method of bridging to disjointed concept maps includes identifying a sub-map of a first concept map that has similar structure to that of a second concept map as illustrated in FIG. 7. Should a consumer's query relate to concept map A 720, and more particularly focus on a specific area, the consumer might have interest in other concepts relating to concept map D 730 having logical similar structures.

FIG. 7 presents concept maps 720 and 730 in a graphical form, where nodes could be keywords and connections represent relationships between nodes. A concept engine could determine that two concept maps 720 and 730 have similar structure if the relationship among nodes is similar even if the nodes represent different key words, as represented by similar sub-maps 740.

Another possible method of bridging to disjointed concept maps can include identifying similar query behaviors among different consumers. If two consumers exhibit similar query behaviors it is possible they have similar tastes, interests, or other common attributes even if the concepts of their queries are different. For example, if consumers' query behavior indicates a shift toward higher quality products where one consumer conducts searches relating to the concept of consumer electronics while a second consumer conducts searches relating to the concept of luxury cars, then the concept engine could determine that the two concepts could be bridged. The determination can be derived based on patterns related to one or more common attributes of the concept maps, or common attributes of the consumer's query behavior. Such an approach allows for an advertiser to increase exposure for their brands based on commensurate behaviors of consumers, especially with respect to consumers' query behaviors, which is often the only point of contact with a consumer. Thus, advertisers can be offered a method for creating opportunities for the consumer to discover the advertiser's brand.

Identifying query behaviors can include many different aspects of recognizing query patterns of the consumer. Patterns could be recognized based on shifting from one concept to another across concept maps in a concept space, shifts in interest within a concept map, movement with respect to common attributes associated with concept maps (e.g., quality, price, brand, times, etc.), identifying similar structures of concept maps, or other aspects relating to queries or concept maps.

### Concept Based Advertising

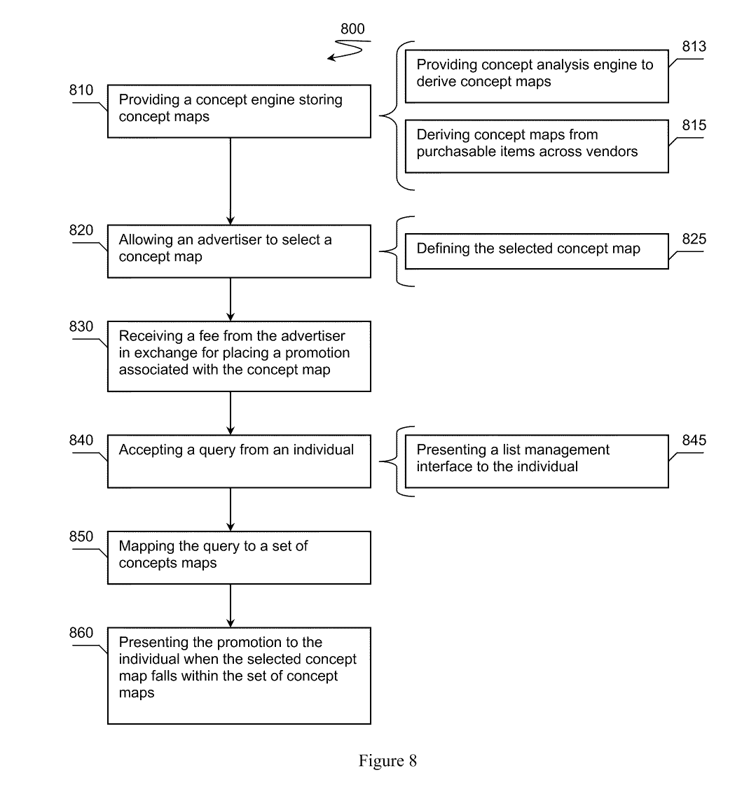

FIG. 8 presents method 800, through which advertisers can present promotions to consumers by having the advertisers brands bound to concepts.

Step 810 can include providing a concept engine configured to store or have access to one or more concept maps. Concept maps can be stored in a database as manageable objects where each concept map comprises quantified attributes associated with a generic concept. Concepts can be wide ranging covering nearly all subject matter. In some basic embodiments, a concept map can include a collection of keywords as discussed with respect to FIG. 4, while in other more complex embodiments a concept map can include attributes normalized to a common attribute namespace, or can include attributes with relationship connections. Providing the concept engine can include installing suitable modules on a computing device. The concept engine can be deployed as part of third party service, as part of a retail change, as part of a public search engine, or other on-line service.

Step 813 can include providing a concept analysis engine configured to derive one or more concept maps. In some embodiments, users of the analysis engine can manually construct a concept map by entering desirable concept attributes. More complex analysis engines are configured to derive automatically concepts maps by analyzing user query behavior as it relates to product information. For example, the analysis engine can establish one or more correlations between a collection of queries (e.g., a set of queries) and products (e.g., goods, services, etc.) where the correlation can be quantized based on one or more common or linking attributes between the set of queries and products, or other purchasable items across vendors as indicated by step 815. One should note the correlation, which can be considered a concept map, can be represented by a collection of attributes and relationships among the attributes, possibly in a multi-dimensioned attribute namespace.

Step 820 can include allowing an advertiser to select a concept map to which they wish to bind their brand. Selecting the concept map can include purchasing access to a concept map, bidding on a concept map, defining a concept map (see step 825) by entering concept map information, or otherwise choosing a desirable concept map. One should appreciate that more than one advertiser can select the same concept map, possibly through an auction. One should also appreciate that concept maps can overlap each other. For example, a first advertiser might have priority for binding their brand to the concept of “Birthday” while a second advertiser might have priority for binding their own brand to the concept of “Birthday Party”. The concept maps for both concepts likely overlap substantially, but can still represent separate, purchasable concepts.

Step 830 includes receiving a fee from the advertiser in exchange for binding the advertiser's promotion with one or more of the selected concept maps. As discussed above the fee could be a flat fee, a winning bid from an auction, or other form of payment. In some embodiments, a winning bid can establish preferential priority for placing the advertiser's promotion when the selected concept is detected. For example, two or more bidders could be considered to have a winning bid. The entity with the highest winning bid would have a greater frequency or prevalence over other winning bidders when their promotion is placed.

Step 840 includes accepting a query from an individual or other user. In more preferred embodiments, the user is a consumer of product and their query represents a search query for the products of interest. In one especially preferred embodiment, the query represents a grocery list submitted to a query engine capable of providing product information across multiple retailers or vendors. For example, a consumer can store one or more lists on a list processing engine which can present the list to the consumer via a list management interface as indicated by step 845. The consumer can modify the list as desired or necessary, and submit the list to the query engine. The query engine or list processing engine can also be integral parts of the concept engine discussed above.

Step 850 can include mapping the query to a set of one or more concept maps available from the concept engine. Mapping the query to the concept maps can be straight forward by matching keywords in the query (e.g., list item names) to attributes of the concept map. In more complex embodiments, the mapping can include establishing one or more correlations between the queries, or even query history, to concept maps via an intermediary bridging namespace. In fact, it is considered advantageous to employ more than one algorithm to conduct the mapping step so that the system can establish a connection to more than one concept map. Each concept map can include a weighting representing a likely relevance to the submitted query.

Step 860 includes presenting promotions to the consumer where the promotions are bound to the correlated concept maps. The promotions take on many different forms. In a preferred embodiment, the promotions are advertisements presented to the user within a browser interface. The interface presents the result sets or promotions according to instructions from the query engine operating as an HTTP server.

### Query Behavior Analysis and Advertising

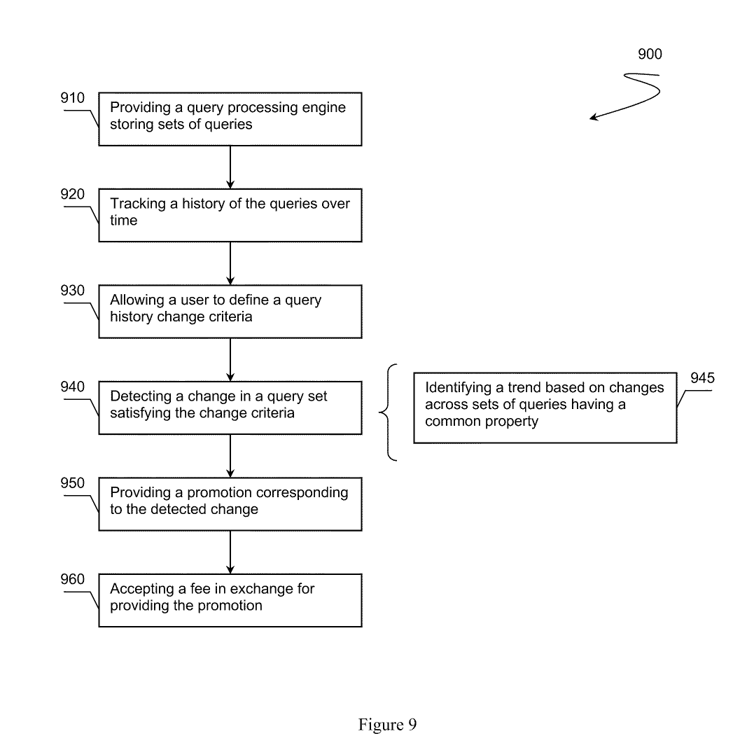

FIG. 9 presents method 900 of offering a promotion to a consumer through analyzing and detecting changes in query behavior.

Step 910 includes providing a query processing engine storing one or more sets of queries. A set of queries can represent one or more queries having a common characteristics or attribute in common. Example attributes could include a user, a demographic, a time frame, a concept, or other type of attribute linking queries together. Furthermore, a set of queries can also include a history or log of queries or even metadata associated with historical queries. The query processing engine retains sets of queries for analysis to determine if one or more changes occur with respect to the set.

Step 920 includes tracking a history of queries over time. By tracking a history of a set of queries, the processing engine can establish one or more baselines of behavior for the set. One should also appreciate that a single query can belong to more than one set of queries and the signal query's history can be applicable to more than one set. One should further appreciate that the query processing engine can store various data associated with a query include pre-query data, query data, or post-query data. Pre-query data is considered to include a user's interact with a query engine, a browser, or other interface leading up to submission of the query. Query data itself can be considered the actual query submitted to the query engine including user-submitted information or automatically submitted information (e.g., browser generated metadata, back-channel data, etc.). Post-query data can include information relating to how the user interacts with a resulting data set after submitting the query. An astute reader will recognize that post-query data can bleed or blend into pre-query data. One aspect of the inventive subject matter includes differentiating between the two, possibly based on applying concept map analysis techniques discussed previously. Concept maps can aid in differentiating which activities are more closely related to a current query versus a previous query. Regardless, the data obtained relating to a query represents historical information that can be brought to bear against determining changes in a query behavior.

Step 930 includes allowing a user to define one or more query history change criterion. Each criterion can include one or more conditions, required or optional, which should be satisfied to indicate that a change in query behavior has occurred. The criterion can be based on attributes associated with a set of queries or metrics related to the attributes. For example, one metric might include rate of submitted queries from a defined demographic relating to a topic. When the measured metric satisfies a threshold condition, a change is considered detected.

Step 940 includes detecting a change in a query set satisfying change criteria. By comparing a current query, or queries, to the historical baseline of the set of queries, the query processing engine can determine the current query deviation from the baseline. When the deviation satisfies the user defined change criteria, the system can take one or more actions. Consider a more specific example. Homemakers might submit grocery lists as queries that require a specific brand of peanut butter. An advertiser can define change criteria associated with the number of queries per unit time that target the brand of peanut butter. If the change is detected, the advertiser can begin presenting promotions to the homemakers accordingly. If the advertiser is associated with the original base, the advertiser might wish to raise awareness about their brand to prevent loss of a consumer brand. If the advertiser is not associated with the original brand, the advertiser might wish to sway the consumer toward the advertiser's brand.

Step 945 can include identifying one or more trends across the set of queries where a trend represents a perceived predictable behavior in one or more attributes with respect to time. In some embodiments, the trend can be identified by collecting one or more changes that occur among queries within the set of queries. To continue with the previous example above, a trend might include a change in the measured rate of queries directed to a brand of peanut butter. In more preferred embodiments, the trend can be established among queries having a common property.

Step 950 includes providing a promotion corresponding to the detected change in query behavior to the entity submitting a query. The promotion can be inserted into a result set sent back the user or positioned about the user's browser interface as desired. Furthermore, the promotion can be placed according to a fee provided by the advertiser wishing to have the promotion placed.

Step 960 includes accepting a fee from the advertiser in exchange for providing the promotion. In some embodiments, the fee is received before placing the promotion while in other embodiments; the fee is received after placing the promotion. It is also contemplated the fee is received in real-time upon presenting the promotion. As discussed previously, the fee can be determined according to various means include a flat fee schedule, a subscription, an auction or other method of generating a fee.

One should note that a detected change in query behavior can also map back to a concept map as described above. A change or deviation from baseline can also be quantified within a common attribute namespace for ease of correlating one object to another. In fact the inventive subject matter is considered to include mapping a query behavior change to a concept map and allowing advertisers to bind their promotions based on the concept map.

### Additional Considerations

One should appreciate there are numerous interesting opportunities that arise out of offering a concept map as a commodity. The following presents additional consideration with respect to the disclosed subject matter.

Static and Dynamic Concept Maps

Concept maps can be static or dynamic. A static concept map represents a map that remains constant over time. The constancy can be determined through various factors, possibly freezing a quantified description of the concept map at the time of purchase. A dynamic concept map represents a concept map that evolves or otherwise changes over time. For example, an advertiser could purchase the right to attach their brand to the concept of “date night”. When purchased, “date night” could represent a having a nice dinner, attending a play, and having drinks. After an economic down turn, “date night” could change or evolve to represent ordering out, watching a rental movie, and going for a walk.

Concepts maps can change according to various factors. For example, metadata associated with the concept might change indicating a shift in a perception about a concept or item within the in concept.

Future Value of Concept Map

Given that a concept map could change with time, one should appreciate that the value of a concept might be able to also change as time passes where a value of the map could increase, or even decrease, with time. Therefore it is specifically contemplated that one could offer a marketplace for concept maps where future access to concept maps is offered for sale. It is thought that such an approach provides for creating or establishing a futures market for concept maps.

Concept Map Management

In a preferred embodiment, entities that obtain access to concepts maps are offered a management interface through which they are able to manage their concept maps. Management of the concept maps can include analyzing productivity of concept maps or promotions, managing promotions associated with concept maps, defining concept maps, configuring criteria to select a promotion, or other management related functionality.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of providing an advertising platform, the method comprising
providing a concept engine configured to store a plurality of concept maps;
allowing an advertiser to select, via an advertiser interface, a first concept map from among the plurality of concept maps;
receiving a fee from the advertiser in exchange for placing a promotion associated with the first concept map;
accepting, by the concept engine, a query from an individual;
mapping, by the concept engine, the query to a set of concept maps from the plurality of concept maps; and
presenting, by the concept engine, the promotion to the individual if the first concept map falls within the set of concept maps.

2. The method of claim 1, wherein the step of allowing an advertiser to select a first concept map includes allowing the advertiser to define the first concept map.

3. The method of claim 1, further comprising a query engine conducting the step of mapping the query to a set of concept maps.

4. The method of claim 3, wherein the query comprises a list.

5. The method of claim 4, further comprising a list processing engine presenting a list management interface to the individual.

6. The method of claim 4, wherein the list comprises purchasable products.

7. The method of claim 1, further comprising providing a concept analysis engine configured to automatically derive at least some of the plurality of concept maps based on a history of queries and based on purchasable items.

8. The method of claim 7, further comprising deriving concept maps from the purchasable items across different vendors.

9. A method of offering a promotion, the method comprising:
providing a query processing engine configured to store a sets of queries;
tracking, by the query processing engine, a history of the sets of the queries over time;
detecting, by the query processing engine, a change in a query set from the sets of queries that satisfies a change criteria; and
providing, by the query processing engine, a promotion to an entity submitting queries to the query processing engine in response to the change.

10. The method of claim 9, further comprising accepting a fee from an advertiser in exchange for providing the promotion.

11. The method of claim 10, further comprising allowing the advertiser to define the change criteria.

12. The method of claim 9, wherein the change criteria depends on at least one of the following query attributes: a location, a rate, a size, a demographic, a price, a product brand, and a consumer.

13. The method of claim 9, wherein the plurality of queries comprises lists of items.

14. The method of claim 9, further comprising identifying a trend based on changes across the set of queries having a common property.

15. The method of claim 14, wherein the common property comprises at least one of following: a geography, a family, a time, a demographic, and a product brand.
